(19) United States
(12) Patent Application Publication
(10) Pub. No.: US 2026/0097914 A1
(43) Pub. Date: Apr. 9, 2026

(54) Safety Barrier Apparatus for Flatbed Loading and Unloading

(71) Applicant: Leum Engineering, Inc. d/b/a Dockzilla Co., Minnetonka, MN (US)

(72) Inventors: Grant Leum, Excelsior, MN (US); Eric Demerath, Shepherd, MI (US)

(73) Assignee: Leum Engineering, Inc. d/b/a Dockzilla Co., Minnetonka, MN (US)

(21) Appl. No.: 18/907,045

(22) Filed: Oct. 4, 2024

(51) Int. Cl. B65G 69/28

(52) U.S. Cl. CPC B65G 69/2876

(57) ABSTRACT

Safety-barrier apparatus for use alongside a flatbed trailer at a loading/unloading location, the apparatus including ground-engaging base structure positioned alongside the flatbed trailer, tiltable L-shaped support members each having an upright L portion and a lower L portion extending toward the loading/unloading location, the upright portion having a top end and the lower portion having a distal end pivotably attached to the base structure such that pivoting the L-shaped support members to a tilted orientation moves the top ends of the upright L portion to positions at a level above and closer to the flatbed surface, and an elongate barrier attached with respect to the top ends of the upright L portions thereby to extend along the flatbed surface.

### FIELD OF THE INVENTION

This invention relates to the field of apparatus for use in facilitating the loading and unloading of trailer trucks for over-the-road shipment of goods, and more specifically to apparatus for carrying out such loading and unloading tasks quickly and safely for the personnel carrying out such tasks. Still more specifically, this invention relates to the field of apparatus facilitating the loading and unloading of flatbed trailers.

### BACKGROUND AND OBJECTS OF THE INVENTION

Flatbed trucks are vehicles equipped with large open-bed trailers designed for transporting heavy loads of various kinds, the flatbed trailer typically pulled by a truck. Flatbed trailers, in addition to their flat beds where goods are placed for shipment, typically have no sides or roof. Such trailers are often simply referred to as Aflatbeds.@ They are often used to transport oversized items which would be difficult or impossible to place in a conventional cargo vehicle. They are used for a wide variety of cargo, whether or not in stacked containers of various kinds. Flatbeds are essential for transportation of goods.

Loading and unloading flatbed trailers is different from loading and unloading conventional cargo vehicles. While loading and unloading goods may be easier and faster than with conventional cargo vehicles, such faster loading and unloading carries with it enhanced risks, including mainly because of the absence of sides. Furthermore, with flatbeds, some racks and other safety features used to secure loads in conventional trucks may not be appropriate for flatbed trailers. Typically, the absence of the enclosure afforded by standard trucks means that, in flatbed shipping, properly lashing the cargo in place on the flatbed with strapping or other flexible means secured in many places along opposite edges of the flatbed is of particular importance. Facilitating the task of edge securement is therefore a matter of importance.

The absence of sides (i.e., sidewalls) which characterize flatbed trailers carries particular risks for personnel walking on flatbeds during loading and unloading operations, and for forklift operators driving back and forth in their load manipulation and adjustment during loading and unloading operations. In short, loading and unloading flatbed trailers can be dangerous, and personnel and operators should always think carefully about how they load and unload flatbeds. Heavy loads, moving vehicles, dropping loads, poor stacking of loads, slipping and falling in icy and snowy conditions on flatbeds, and working at heights above the ground can all cause injuries or even death. Government statistics on such accidents show this to be a specific concern.

Given that standard flatbed trailers have a surface height on the order of five feet, and also given that, under standards of the United States Occupational Safety and Health Act (OSHA), fall protection is mandatory for workers operating at heights exceeding four feet, it can be seen that flatbed loading and unloading is usually, or at least very often, at heights greater than the OSHA standards. This shows the need for apparatus created to provide protection against falls for those engaged in loading and unloading of flatbed trailers.

These and other particular concerns and problems indicate that there is a need for an apparatus to greatly improve the safety of personnel involved in loading and unloading of flatbed trailers, including safety-barrier apparatus that accommodates particular safety and ease-of-use concerns, and facilitates all aspects of loading and unloading operations for flatbed trailers.

### OBJECTS OF THE INVENTION

It is an object of the present invention to provide apparatus which addresses, ameliorates, and serves to overcome the many safety concerns of flatbed trailer loading and unloading operations, including those referred to above.

Another principal object of the invention is to provide improved safety-barrier apparatus specifically accommodating needs associated with loading and unloading operations for flatbed trailers, and directly addressing pertinent regulatory requirements.

Yet another object of the invention is to provide, in such apparatus, a conveniently located above-ground walking surface well situated to facilitate the necessary lashing of loads for security purposes and their unlashing prior to unloading after transport.

Another important object is to provide a safety-barrier apparatus for use in flatbed loading and unloading which very simply and quickly accommodates safety needs for moving and situating cargo onto a flatbed and immediately thereafter lashing such cargo in place during loading operations and, during unloading operations, first unlashing cargo from its secure positions on the flatbed and immediately thereafter picking up and removing such cargo from the flatbed.

Other objects are to provide easily-used guide location indicators in such apparatus to facilitate truckers=backing into and locating their flatbed trailers in the proper locations for loading and unloading operations, and to enhance such guidance by helpful lighting along wheelguide structures.

Still another object is to facilitate safety of personnel walking on flatbeds for loading and unloading purposes by inclusion in the inventive apparatus handrails along safety barriers.

Other objects are to enhance safety features in such apparatus by inclusion of audible and/or visual warning devices and shield structures, or to protect and enhance the long useful life of the apparatus by use of replaceable wear-surface members and anti-abrupt transition structures inevitably impacted by equipment and cargo movements from time to time.

These and other objects of the invention will be apparent from the following descriptions and from the drawings described below.

### SUMMARY OF THE INVENTION

The present invention is a safety-barrier apparatus for use alongside flatbed trailers at their loading/unloading locations. The apparatus significantly increases the safety and peace-of-mind of persons engaged in loading and unloading flatbed trailers.

These advantages apply to drivers of forklifts and users of other common equipment facilitating loading and unloading, stacking and unstacking of containers and other goods of various kinds on flatbed trailers. The invention also significantly facilitates the jobs of those engaged in securing and releasing cargo containers and/or other goods on surfaces of flatbed trailers by lashing/unlashing, strapping/unstrapping, or other securing/releasing operations along the opposite sides of a flatbed,. Preferred embodiments of the inventive apparatus also facilitate the difficult task faced by flatbed trailer drivers in backing their flatbed trailers into position for loading and unloading purposes, and provide numerous other ease-of operation and safety-related advantages for those engaged in loading and unloading flatbed trailers.

The inventive safety-barrier apparatus includes (1) ground-engaging base structure for positioning alongside the flatbed, (2) at least two tiltable L-shaped support members, each having an upright L portion and a lower L portion extending therefrom toward the loading/unloading location, the upright L portion having a top end and the lower L portion having a distal end pivotably attached to the base structure such that pivoting the L-shaped support members from an upright orientation to a tilted orientation moves the top ends of the upright L portions to positions at a level above and closer to the flatbed surface, and (3) an elongate barrier attached with respect to the top ends of the upright L portions thereby to extend along the flatbed surface.

In highly preferred embodiments, the base structure includes at least two base-structure units spaced from one another, with each of the base structure units having one of the tiltable L-shaped support members pivotably attached thereto. Highly preferred embodiments also include elongate walkway structure secured therealong in position to provide an above-ground walking surface adjacent to the flatbed trailer. Highly preferred embodiments further include an elongate wheelguide structure secured with respect to the ground and extending along the length of the apparatus, although the wheelguide structure may be otherwise secured.

It is also preferred that the wheelguide structure have horizontal support members spaced therealong and extending outwardly therefrom, with the walkway structure being supported atop the horizontal support members to provide the above-ground flatbed-adjacent walking surface. While securement of the walkway structure to the wheelguide structure atop such horizontal support members is preferred, other configurations and securement of the walkway structure are possible and will now be described.

In one such embodiment, the walkway structure is secured directly to the ground, and the walkway structure has at the top thereof the above-ground walking surface adjacent to the flatbed trailer. In such embodiments, the ground-secured walkway structure will include plural structures between and, as appropriate beyond, plural (usually two) base-structure units.

Another useful alternative for the walkway structure, in situations where there are at least two base-structure units each with its respective L-shaped support member as described above, is to have the walkway structure secured atop the lower L portions of the L-shaped support members. With such securement and configuration, when the L-shaped support members are in their upright orientation, the walkway will be in a horizontal orientation, enabling users to use the walkway surface while working alongside the flatbed trailer for lashing/unlashing purposes after the flatbed is loaded or before it has been unloaded.

Referring again to the wheelguide structure, it is preferred that the wheelguide structure include an aligned plurality of wheelguide structure-portions each secured directly to the ground, and each wheelguide structure-portion having a pair of the horizontal support members therealong for supporting the walkway structure. And whether or not the wheelguide structure has plural wheelguide-structure portions, it is preferred that the wheelguide structure includes light sources secured therealong.

Referring now specifically to the barrier function of the inventive apparatus, it is preferred that the apparatus include a handrail secured along the elongate barrier, since this will be a useful aid to workers engaged on the flatbed trailer in placing and arranging cargo containers and other goods on the flatbed surface. It is also preferred that the elongate barrier include elongate wear-surface members which are removably and replaceably secured along the elongate barrier in an inward position, facing the location at which loading and unloading occur. This will facilitate periodic replacement after normal wear has occurred.

The aforementioned tilting of each of the L-shaped support members preferably involves pivoting each of the support members from its upright orientation to its tilted orientation by a tilt actuator engaging the L-shaped support member. The pivoting of the L-shaped support members allows modest linear movement of an actuator to move the top end of the upright L portion from a position away from the flatbed surface to a position closely adjacent to and above the level of the flatbed surface. In preferred embodiments, this is accomplished by the lower portion of the L-shaped support member being pivotably attached to the base structure (e.g., to its related base-structure unit) and the tilt actuator engaging the L-shaped support member at a position spaced from the pivot axis such that actuation thereof tilts the L-shaped support members. The tilt actuator is preferably a hydraulic actuator.

Certain preferred embodiments include signal devices actuated by operation of the tilt actuator to provide audible and visual warnings of movements of the L-shaped support members between their upright and tilted orientations, and movement of the related apparatus.

A further safety-related feature involves the ground-engaging base-structure units each being configured to include a base plate and guard plates secured to the base plate on either side of the tiltable L-shaped support member. This apparatus is configured to protect users against any pinching of a human foot or other appendage between the base plate and the L-shaped support member.

Still another preferred embodiment includes an anti-abrupt transition structure secured at the end (opposite ends) of the elongate barrier, the anti-abrupt transition structures being positioned and configured to absorb impact upon inadvertent vehicle contact therewith.

In yet another aspect of this invention, the safety-barrier apparatus includes (1) the ground-engaging base structure as described above for positioning alongside the flatbed trailer, (2) at least two tiltable support members each having an upright portion and a lower portion extending therefrom toward the loading/unloading location, the upright portion having a top end and the lower portion having a distal end pivotably attached to the base structure such that pivoting the support member moves the top end thereof to a position at a level above and closer to the flatbed surface, and (3) an elongate barrier attached with respect to the top ends of the upright portions thereby to extend along the flatbed surface. In other words, the main actuating portions of the apparatus are described somewhat differently. It will be seen that many of the preferred embodiments as described are applicable.

For their use in repetitive loading and unloading of flatbed trailers, two of the above-described safety-barrier apparatuses are used, parallel to one another and engaged to the ground with spacing therebetween accommodating the typical width of standard flatbed trailers. The spacing is such that the tilting/untilting movements serve (1) to position the elongate barriers where they can perform their intended barrier function on either side of the flatbed or (2) to position them back enough to accommodate walkway access for personnel engaged in load securing/unsecuring functions on either side of the flatbed.

While the parallel spacing of a pair of the inventive safety-barrier apparatuses at a loading/unloading site is made for standard flatbed trailers, it is important to note that, even when installed for normal flatbed loading, the tilting movements which serve to position the elongate barriers alongside a flatbed can be stopped at any point during the tilting movement. This control allows the inventive apparatus to be used in a way accommodating particularly wide loads or even off-center loads. And separate tilting of the two safety-barrier apparatuses can provide additional benefits for unusual loads of odd shapes and sizes.

The term Aoutwardly@ as used herein with respect to the direction in which the horizontal support members (which support the walkway structure) extend means in a lateral direction away from the loading/unloading location.

### BRIEF DESCRIPTION OF THE FIGURES

FIG. 1 is a perspective view of a flatbed truck and its non-loaded flatbed trailer positioned between a pair of preferred safety-barrier apparatuses in accordance with this invention along each of the opposite sides of the flatbed, with each safety barrier in tilted position to provide its safety function when on-flatbed operations are occurring.

FIG. 2 is an enlarged perspective view of one safety-barrier apparatus, but in its upright orientation.

FIG. 2A is an enlarged perspective view of a portion of FIG. 2, as indicated in FIG. 2.

FIG. 2B is an enlarged perspective view of the same portion of FIG. 2, but in its tilted orientation.

FIG. 3 is an inside elevation view of FIG. 2.

FIG. 3A is an enlarged portion of FIG. 3 as indicated in FIG. 3.

FIG. 4 is a top plan view of the pair of the safety-barrier apparatuses as in FIG. 1, but with the flatbed trailer not between them.

FIG. 4A is a fragmentary portion of FIG. 4.

FIG. 5 is an enlarged end elevation view of FIG. 4, showing the two safety-barrier apparatuses in their proper ground-mounted positions and in an orientation ready to receive a flatbed trailer therebetween.

FIG. 6 is a similar end elevation but with a flatbed trailer positioned between the safety-barrier apparatuses.

FIG. 7 is yet another similar elevation but with the safety-barrier apparatuses in their tilted orientation for the loading of cargo onto the flatbed, and showing a forklift on the flatbed ready for its loading operations.

FIG. 8 is like FIG. 7 except that it shows a person on the flatbed ready for loading operations.

FIG. 9 is like FIG. 8, but with the safety-barrier apparatuses in their upright orientation for the lashing of cargo (not shown) onto the flatbed and the person on the walkway in position to do so.

FIG. 10 is a further-enlarged end elevation view of the safety-barrier apparatus, showing such apparatus in its tilted orientation.

FIG. 11 is similar to FIG. 10 but showing the apparatus in its upright orientation.

FIG. 12 is a partially-exploded and further-enlarged fragmentary perspective view of certain portions of the safety-barrier apparatus, showing among other things a highly preferred manner of walkway-structure securement, which is atop horizontal support members along elongate wheelguide structure secured to the ground.

FIG. 13 is a partially-exploded perspective view of another embodiment of the safety-barrier apparatus of this invention, showing an alternative walkway-mounting structure, this one in which the walkway structure is secured directly to the ground and includes the above-ground walking surface at the top thereof.

FIG. 14 is a perspective view of another embodiment of the safety-barrier apparatus of this invention, showing an alternative walkway-mounting structure, the apparatus being in its upright orientation for lashing/unlashing of cargo on a flatbed.

FIG. 15 is a similar perspective view of such embodiment, but showing the apparatus being in its titled orientation for moving cargo onto or off the flatbed.

FIG. 16 is an end elevation of the apparatus seen in FIG. 15.

### DETAILED DESCRIPTION OF PREFERRED EMBODIMENTS

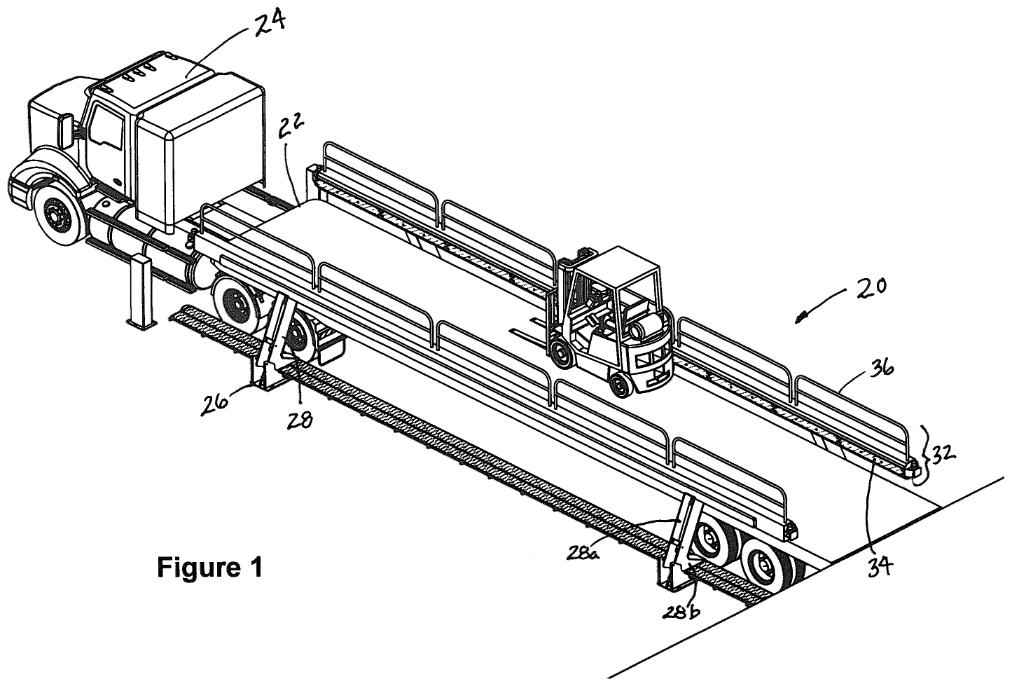

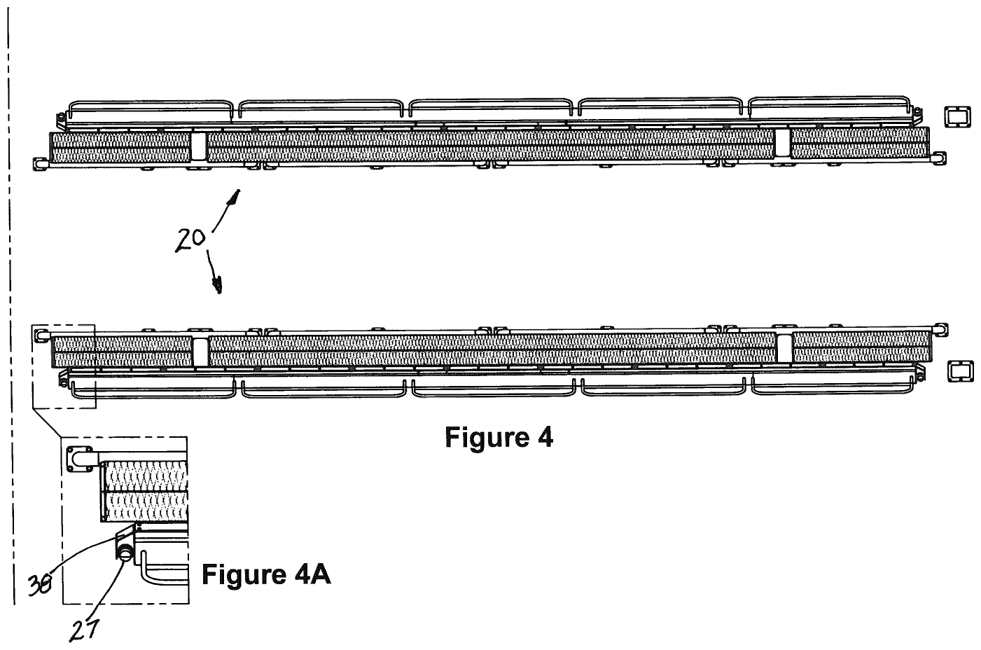

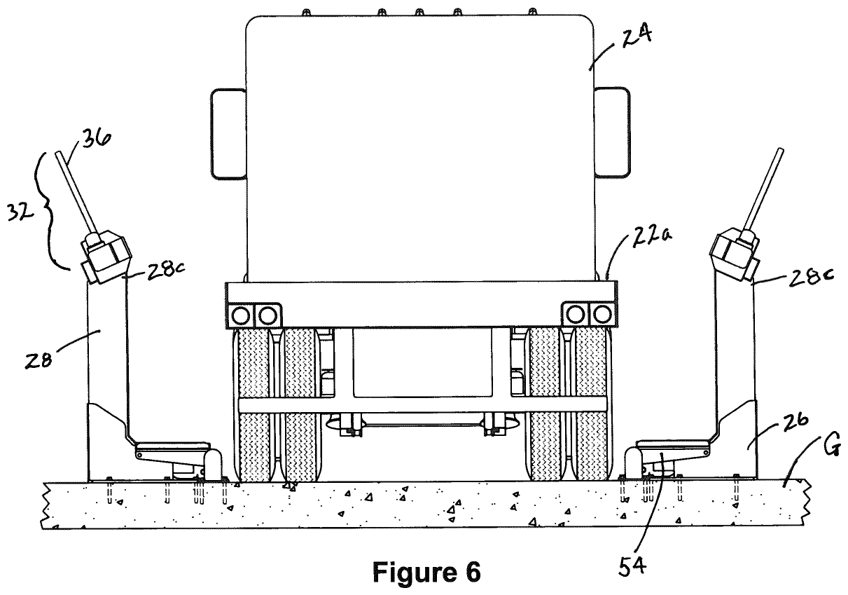

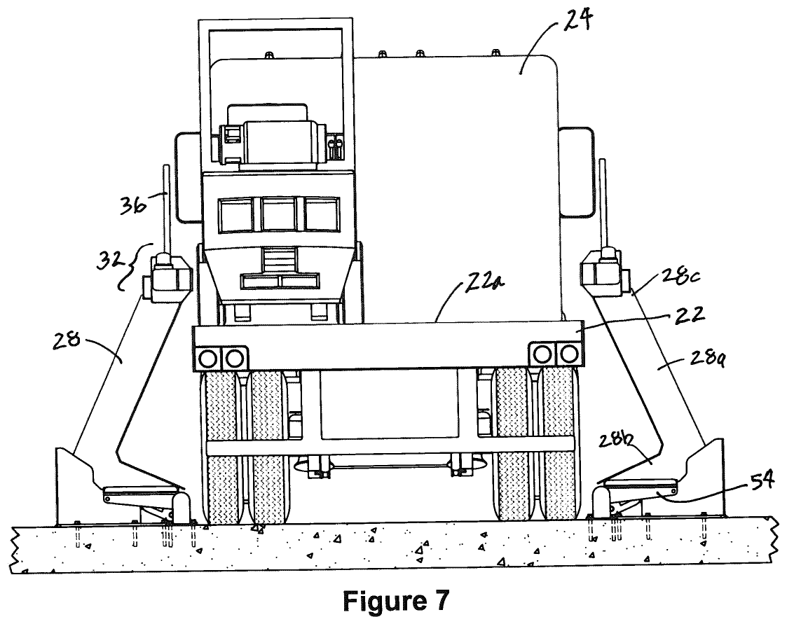

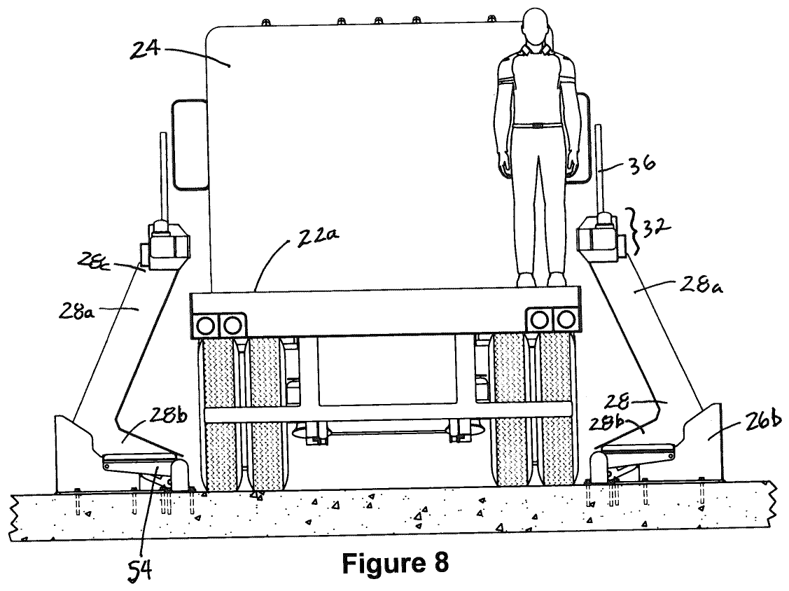

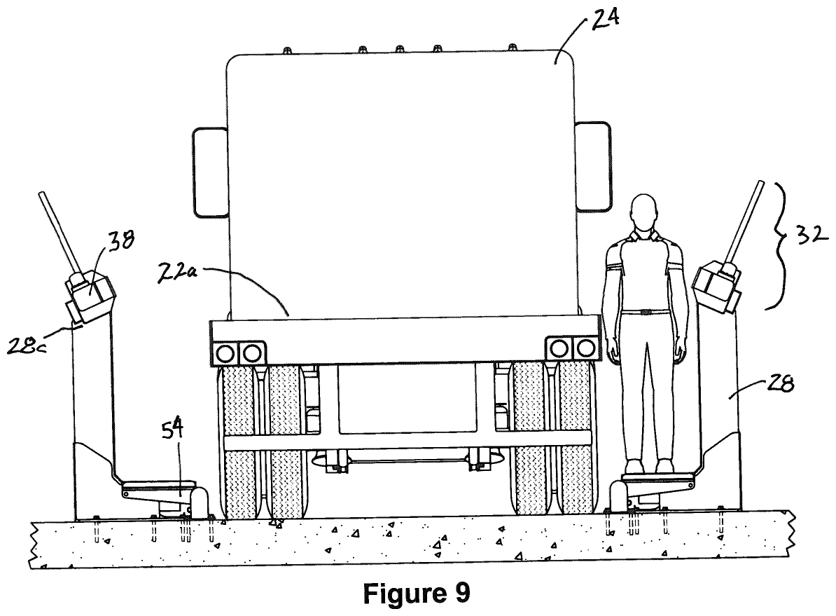

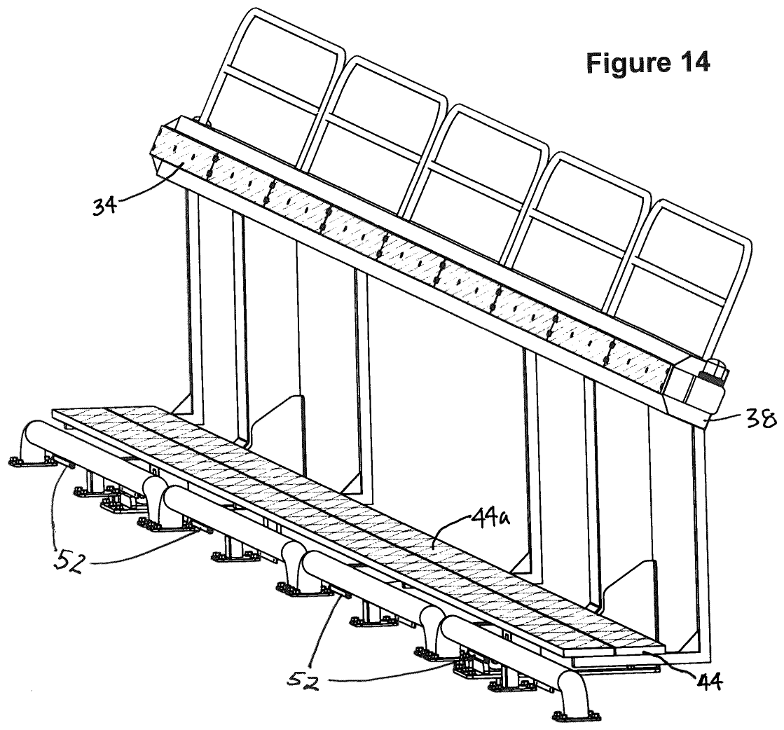

FIGS. 1-12 illustrate in various ways safety-barrier apparatus 20 which is a highly preferred embodiment of the invention. FIGS. 13-16 relate to and illustrate two variations in one aspect of the invention, involving only alternative configurations for securement of the walkway structure, other aspects of such embodiments being consistent with the preferred embodiment of FIGS. 1-12. The term Asafety-barrier apparatus@ referred to in this document is sometimes simply replaced by the terms Asafety barrier@ or Asafety barriers.@

The ground to which the safety-barrier apparatus is secured is marked by letter AG@ as seen in several of the drawings. The ground is typically concrete or of another typical dock-adjacent road material on which trucks move in connection with preparing for their loading/unloading operations. Securement of the apparatus and its components to ground G may be by bolting, and this is represented at various places in the drawings.

FIG. 1, as already noted, shows two of the inventive safety barriers 20 along either side of flatbed trailer 22, which has been backed into its position between them by the driver of truck cab 24. As shown in several of the figures, each of the inventive safety barriers includes a spaced pair of ground-engaging base-structure units 26 for positioning alongside flatbed 22, each of the ground-engaging base-structure units 26 has thereon a tiltable L-shaped support member 28. Each tiltable L-shaped support member 28 has an upright L portion 28a and a lower L portion 28b which extends from upright L portion 28a toward the loading/unloading location where flatbed 22 is between safety barriers 20.

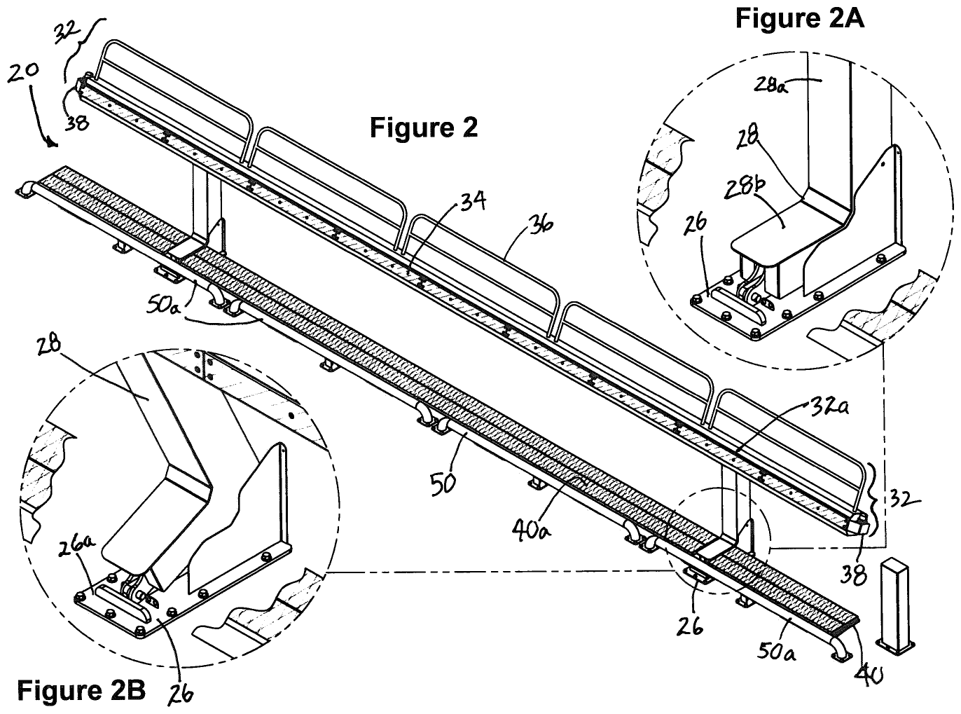

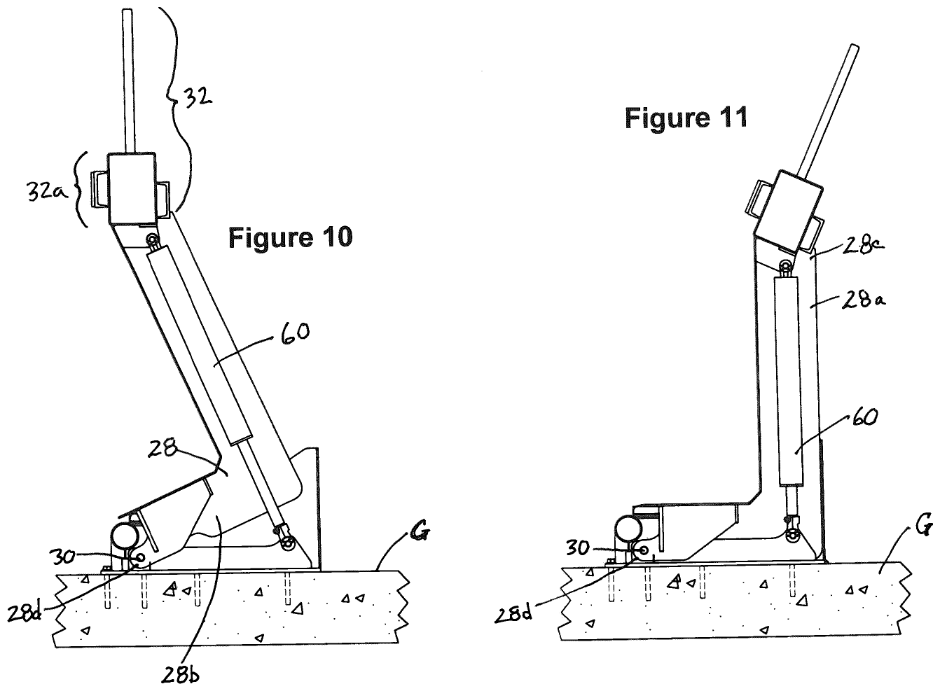

Each upright L portion 28a has a top end 28c and the corresponding lower L portion 28b has a distal end 28d which is pivotably attached to base-structure unit 26 at pivot 30, for pivoting of L-shaped support member 28 about a pivot axis. Pivot 30 is seen in FIGS. 10 and 11, and elsewhere in the drawing figures. Given that lower L portion 28b and upright L portion 28a form part of rigid L-shaped support member 28, the pivoting of L-shaped support members 28 from an upright orientation to a tilted orientation moves top ends 28c of upright L portions 28a to positions at a level above and closer to flatbed surface 22a. The upright orientation of L-shaped support member 28 is seen best in FIGS. 2, 2A, 5, 6, 9, 11 and 14; the tilted orientation of L-shaped support member 28 is seen best in FIGS. 1, 2B, 7, 8, 10, 15 and 16.

An elongate barrier 32 of each safety-barrier apparatus 20 is attached to top ends 28c of upright L portions 28a, and thereby extends along flatbed surface 22a, in the position dictated by whether L-shaped support members 28 are in their upright orientation or their tilted orientation. When L-shaped support members 28 are in their tilted orientation, elongate barrier 32 is in a position at a level above and closer to flatbed surface 22a, and so in position to perform its key safety functions of providing assurance that personnel as well as lift trucks and other equipment remain on flatbed surface 22a. When L-shaped support members 28 are in their upright orientation, elongate barrier 32 is in a position farther away from flatbed surface 22a, thus facilitating lashing and unlashing operations and the like by personnel along the edge of flatbed 22 by standing on and walking along above-ground walking surface 40a of walkway structure 40.

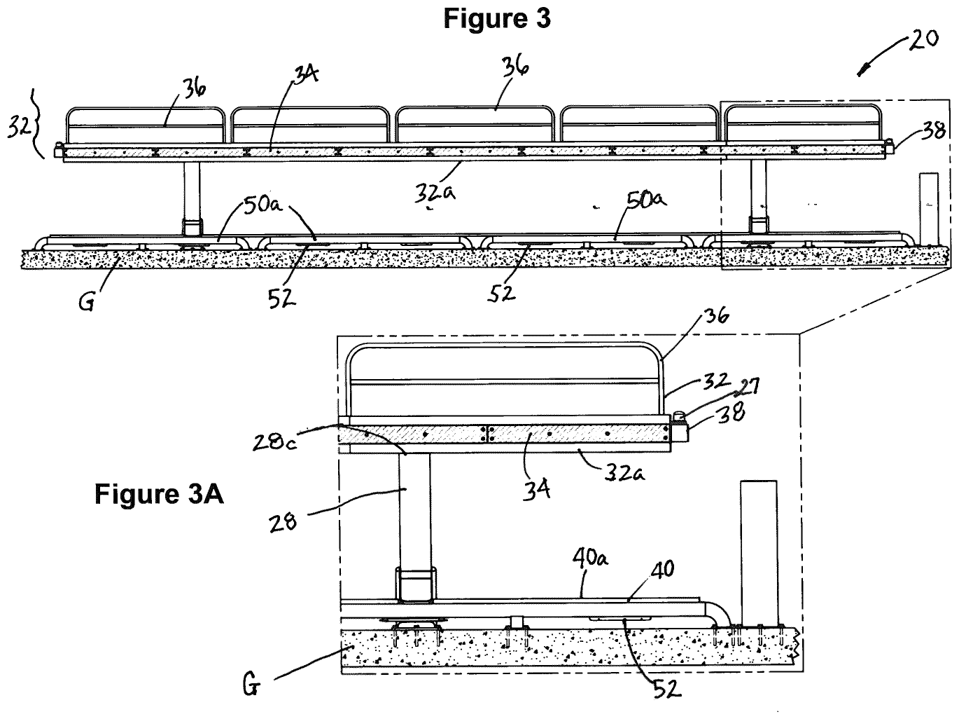

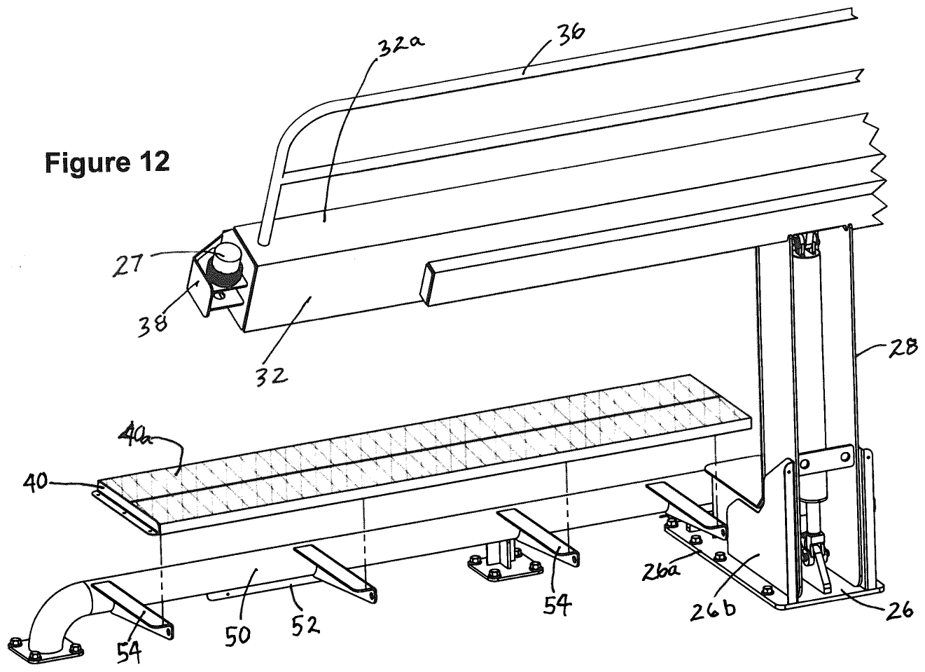

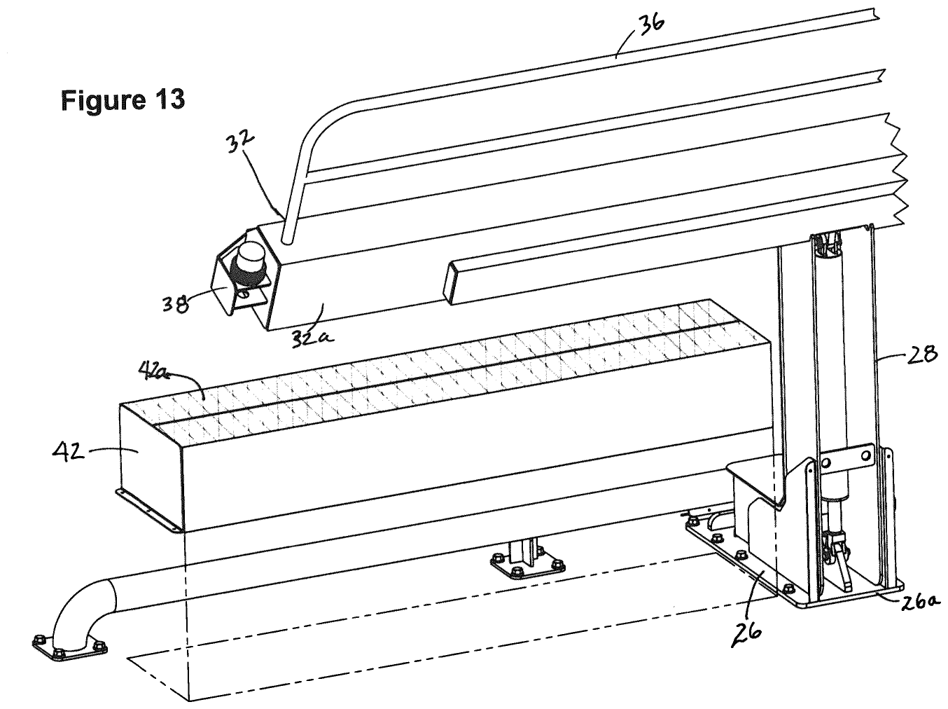

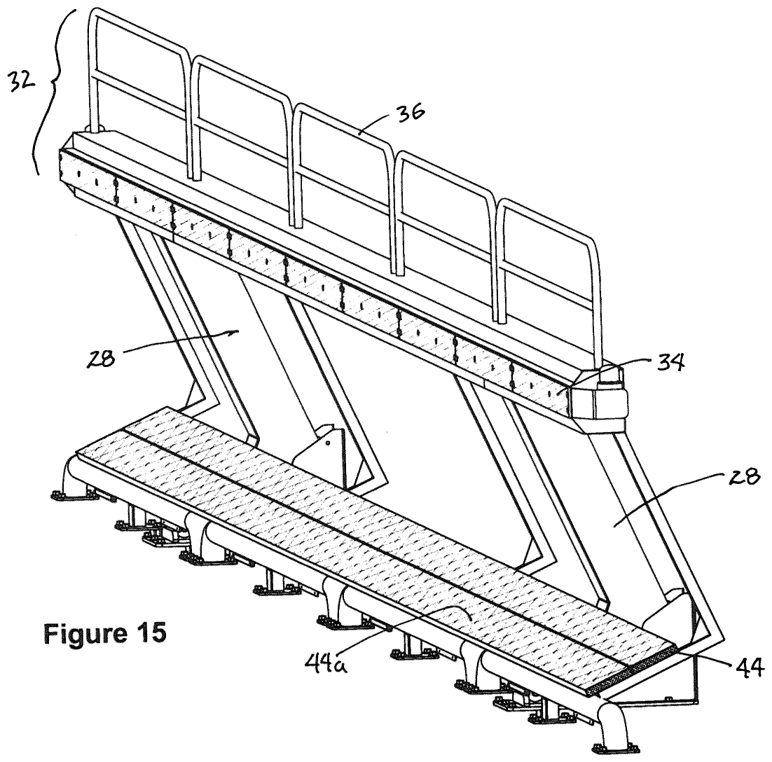

Safety-barrier apparatus 20 also includes an elongate wheelguide structure 50 which is secured with respect to ground G extending along the length of the apparatus. Wheelguide structure 50, seen in many of the drawing figures, is perhaps seen best in FIGS. 2 and 12. Wheelguide structures 50 of safety-barrier apparatuses 20 on either side of the flatbed trailer 22 in effect define the loading/unloading location. As seen best in FIG. 2, wheelguide structure 50 has a number of aligned wheelguide structure portions 50a, each secured to the ground. The guiding function of wheelguide structure 50 is enhanced, particularly when ambient or area lighting is low, by inclusion of light sources 52 secured along wheelguide structure portions, preferably positioned near or on the underside thereof in position to illuminate adjacent ground surface. Light sources 52, which preferably consist of LEDs, are seen best in FIGS. 3, 3A and 14.

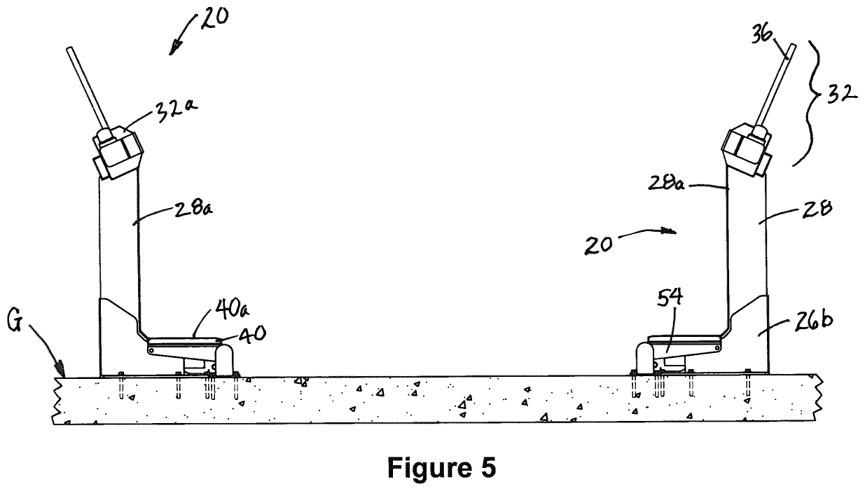

As seen best in FIG. 12 and FIGS. 5-9, wheelguide structure 50 has horizontal support members 54 spaced therealong and extending outwardly therefrom. Walkway structure 40 is supported and secured on top of horizontal support members 54, thereby providing above-ground flatbed-adjacent walking surface 40a alongside flatbed trailer 22. This is a preferred manner of configuring and securing the walkway structure.

As noted above, FIGS. 13-16 illustrate two variations involving alternative configurations for securement of the walkway structure.

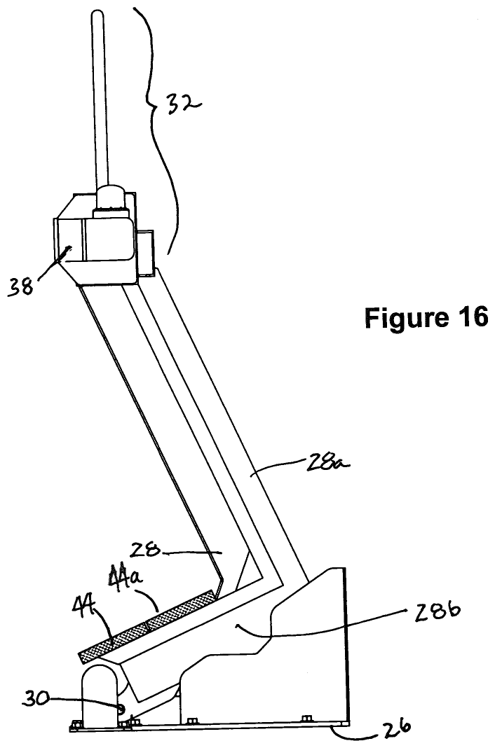

FIG. 13 illustrates walkway structure 42 which would be directly secured to ground G, and walkway structure 42 provides above-ground walking surface 42a at the top thereof, in position to be adjacent the flatbed trailer. In such embodiments, ground-secured walkway structure 42 will include plural structures between, and as appropriate beyond, plural (usually two) base-structure units 26, one of which is seen in FIG. 13. The other alternative for configuration and securement of the walkway structure is seen in FIGS. 14-16. In this configuration, walkway structure 44 is secured on top of lower L portions 28b of L-shaped support members 28. Therefore, when L-shaped support members 28 are in their upright orientation, walkway structure 44 and its above-ground walking surface 44a will be in a horizontal orientation, as seen in FIG. 14, thus enabling users to use walkway surface 44a to work alongside flatbed trailer 22 for lashing/unlashing purposes after flatbed surface 22a is loaded, or before it has been unloaded. However, when L-shaped support members 28 are in their tilted orientation, as seen in FIGS. 15 and 16, walkway structure 44 and its above-ground walking surface 44a will be tilted, appropriately discouraging personnel on the ground from being immediately adjacent to flatbed trailer 22 when cargo is being moved about flatbed surface 22a.

As seen in many of the drawing figures, elongate barrier 32 includes a main portion 32a which is of sufficient size that when L-shaped support members are in their tilted orientation, main portion 32a is positioned to prevent inadvertent falling of a lift truck, other equipment, or cargo from flatbed surface 22a. Given all the motions and activity which are involved in loading and unloading of flatbeds, main portion 32a of elongate barrier 32 will experience wear. Removably secured at inward positions along elongate-barrier main portion 32a are wear-surface members 34, which can be removed and replaced after years of use or whenever appropriate. Suitable materials for wear-surface members can include certain plastics, including without limitation those which can absorb impacts, and also wood.

As seen in most of the drawing figures, elongate barrier 32 includes handrails 36 secured therealong for use by personnel working on flatbed surface 22a during loading and unloading operations. Handrails 36 are positioned at a level higher than elongate-member main portion 32a, in position for easy grasping by personnel when necessary or helpful.

As seen in FIGS. 1-4 and other figures, secured at the opposite ends of elongate-barrier main portion 32a is an anti-abrupt transition structure 38. Such structures are of known type, and in safety-barrier apparatus 20 are positioned and configured to deflect and absorb impact upon inadvertent vehicle contact with the apparatus.

Turning again to the tilting and untilting motions of L-shaped support members 28 involving pivoting around their pivots 30, this is caused by tilt actuators in the form of hydraulic actuators 60, one for each L-shaped support member 28, actuated by simple operator controls (not shown). The location and engagement of hydraulic actuators 60 are illustrated best by reference to FIGS. 10 and 11, which show an hydraulic actuator 60 engaged at one end to base structure unit 26 and at the opposite end to L-shaped support member 28 at a position spaced from pivot 30. The exact configuration and attachment are done to provide the desired tilting. Operation and powering of the tilting mechanisms will be apparent to those skilled in the art when made aware of this invention. Safety-barrier apparatus 20 also includes audible and visual signal devices 27 configured to provide warnings of tilting and untilting movements of the apparatus, and suitable controls for such devices 27 will also be apparent to those skilled in the art.

Referring now to FIGS. 5-9 and 12, it can be seen that each ground-engaging base-structure unit 26 is configured to include a base plate 26a and guard plates 26b secured to base plate 26a on either side of tiltable L-shaped support member 28. This configuration protects users against any pinching of a human foot or other appendage between L-shaped support member 28 and base plate 26a.

Throughout this specification, many details have been given to show how to make various embodiments of this invention. Additional information would be readily available to those skilled in the field who are made aware of this invention disclosure.

While the principles of this invention have been described in connection with specific embodiments, it should be understood clearly that these descriptions are made only by way of example and are not intended to limit the scope of the invention.

1. Safety-barrier apparatus for use along the side of a flatbed trailer at a loading/unloading location, the apparatus comprising:
$ ground-engaging base structure for positioning alongside the flatbed trailer;
$ at least two tiltable L-shaped support members each having an upright L portion and a lower L portion extending therefrom toward the location, the upright L portion having a top end and the lower L portion having a distal end pivotably attached to the base structure such that pivoting the L-shaped support members from an upright orientation to a tilted orientation moves the top ends
of the upright L portions to positions at a level above and closer to the flatbed surface; and
$ an elongate barrier attached with respect to the top ends of the upright L portions thereby to extend along the flatbed surface.

2. The apparatus of claim 1 further including elongate walkway structure secured therealong, thereby providing an above-ground walking surface adjacent to the flatbed trailer.

3. The apparatus of claim 1 wherein the base structure includes at least two base-structure units spaced from one another, each of the base structure units having one of the tiltable L-shaped support members pivotably attached thereto.

4. The apparatus of claim 1 further including an elongate wheelguide structure secured with respect to the ground and extending along the length of the apparatus.

5. The apparatus of claim 4 wherein the wheelguide structure includes light sources secured therealong.

6. The apparatus of claim 4 wherein the wheelguide structure is secured directly to the ground.

7. The apparatus of claim 6 wherein the wheelguide structure has horizontal support members spaced therealong and extending outwardly therefrom, and walkway structure is supported atop the horizontal support members, thereby providing an above-ground flatbed-adjacent walking surface.

8. The apparatus of claim 6 wherein the wheelguide structure includes an aligned plurality of wheelguide structure-portions each secured directly to the ground, each wheelguide structure-portion having a pair of the horizontal support members therealong.

9. The apparatus of claim 2 wherein the walkway structure is secured directly to the ground, the walkway structure having at the top thereof the above-ground walking surface.

10. The apparatus of claim 2 wherein:
$ the base structure includes at least two base-structure units spaced from one another, each of the base structure units having one of the tiltable L-shaped support members pivotably attached thereto; and
$ the walkway structure is secured atop the lower L portions and is in a horizontal orientation when the L-shaped support members are in an upright orientation.

11. The apparatus of claim 1 further including a handrail secured along the elongate barrier.

12. The apparatus of claim 1 further including an elongate wear-surface member removably secured along the elongate barrier in an inward position facing the loading/unloading location, thereby facilitating periodic replacement.

13. The apparatus of claim 1 wherein each of the L-shaped support members is pivoted from its upright orientation to its tilted orientation by a tilt actuator engaging the L-shaped support member.

14. The apparatus of claim 13 wherein:
$ the pivotable attachment of the lower L portion to the base structure is along a pivot axis; and
$ the tilt actuator engages the L-shaped support member at a position spaced from the pivot axis such that actuation thereof tilts the L-shaped support members.

15. The apparatus of claim 13 wherein the tilt actuator is an hydraulic actuator.

16. The apparatus of claim 1 further including signal devices actuated by operation of the tilt actuator to provide audible and visual warnings of movements of the L-shaped support members between their upright and tilted orientations.

17. The apparatus of claim 1 wherein the ground-engaging base structure includes at least two base-structure units, each base-structure unit including a base plate and guard plates secured to the base plate on either side of the tiltable L-shaped support member, thereby protecting users against pinching between the L-shaped support member and the base plate.

18. The apparatus of claim 1 further including an anti-abrupt transition structure secured at the end of the elongate barrier, the anti-abrupt transition structure positioned and configured to absorb or deflect impact upon inadvertent vehicle contact therewith.

19. Safety-barrier apparatus for use along the side of a flatbed trailer at a loading/unloading location, the apparatus comprising:
$ ground-engaging base structure for positioning alongside the flatbed trailer;
$ at least two tiltable support members each having an upright portion and a lower portion extending therefrom toward the location, the upright portion having a top end and the lower portion having a distal end pivotably attached to the base structure such that pivoting the support member moves the top end thereof to a position at a level above and closer to the flatbed surface; and
$ an elongate barrier attached with respect to the top ends of the upright portions thereby to extend along the flatbed surface.

20. The apparatus of claim 19 further including elongate walkway structure secured therealong, thereby providing an above-ground walking surface adjacent to the flatbed trailer.

21. The apparatus of claim 19 wherein the ground-engaging base structure includes at least two base-structure units spaced from one another, each of the base structure units having one of the tiltable support members pivotably attached thereto.

22. The apparatus of claim 19 further including an elongate wheelguide structure secured with respect to the ground and extending along the length of the apparatus.

23. The apparatus of claim 22 wherein the wheelguide structure has horizontal support members spaced therealong and extending outwardly therefrom, and walkway structure is supported atop the horizontal support members, thereby providing an above-ground flatbed-adjacent walking surface.
